(19) United States
(12) Patent Application Publication
(10) Pub. No.: US 2018/0208209 A1
(43) Pub. Date: Jul. 26, 2018

(54) COMFORT PROFILES

(71) Applicant: Apple Inc., Cupertino, CA (US)

(72) Inventors: Ahmad Al-Dahle, Cupertino, CA (US); Byron B. Han, Cupertino, CA (US)

(73) Assignee: Apple Inc., Cupertino, CA (US)

(21) Appl. No.: 15/758,329

(22) PCT Filed: Sep. 7, 2016
(86) PCT No.: PCT/US16/50567

§ 371 Date: Mar. 7, 2018

Related U.S. Application Data
(60) Provisional application No. 62/215,666, filed on Sep. 8, 2015.

(51) Int. Cl. B60W 50/00; G05D 1/02; G05D 1/00

(52) U.S. Cl. CPC B60W 50/0098; B60W 10/22; G05D 1/0088; G05D 1/0212

(57) ABSTRACT

Some embodiments provide an autonomous navigation system which can navigate a vehicle through an environment according to a selected comfort profile, where the comfort profile associates a particular set of occupant profiles and a particular set of driving control parameters, so that the vehicle is navigated based on the particular set of driving control parameters. The comfort profile is selected based on a determined correlation between the occupants detected in the vehicle interior and the occupants specified by the set of occupant profiles included in the comfort profile. The driving control parameters included in a comfort profile can be adjusted based on monitoring occupants of the vehicle for feedback when the vehicle is being autonomously navigated according to the comfort profile.

This application is a 371 of PCT Application No. PCT/US2016/050567, filed Sep. 7, 2016, which claims benefit of priority to U.S. Provisional Patent Application No. 62/215,666, filed Sep. 8, 2015. The above applications are incorporated herein by reference. To the extent that any material in the incorporated application conflicts with material expressly set forth herein, the material expressly set forth herein controls.

### BACKGROUND

### Technical Field

This disclosure relates generally to navigation of a vehicle, and in particular to autonomous navigation of the vehicle according to a selected comfort profile which is selected based on monitored occupancy of the vehicle.

### Description of the Related Art

The rise of interest in autonomous navigation of vehicles, including automobiles, has resulted in a desire to develop autonomous navigation systems which can autonomously navigate (i.e., autonomously “drive”) a vehicle through various routes, including one or more roads in a road network, such as contemporary roads, streets, highways, etc. Such autonomous navigation systems can control one or more automotive control elements of the vehicle to implement such autonomous navigation. Such control by the autonomous navigation system in a vehicle can be referred to as autonomous driving control of the vehicle.

### SUMMARY OF EMBODIMENTS

Some embodiments provide an autonomous navigation system which can navigate a vehicle through an environment according to a selected comfort profile, where the comfort profile associates a particular set of occupant profiles and a particular set of driving control parameters, so that the vehicle is navigated based on the particular set of driving control parameters. The comfort profile is selected based on a determined correlation between the occupants detected in the vehicle interior and the occupants specified by the set of occupant profiles included in the comfort profile. The driving control parameters included in a comfort profile can be adjusted based on monitoring occupants of the vehicle for feedback when the vehicle is being autonomously navigated according to the comfort profile.

Some embodiments provide an apparatus which includes an autonomous navigation system which can be installed in a vehicle and autonomously navigates the vehicle through an environment in which the vehicle is located based on a selected comfort profile. The autonomous navigation system selects a comfort profile, from a set of comfort profiles, based on a determined correlation between a set of detected occupant profiles, generated based on a set of occupants detected within an interior of the vehicle, and a set of occupant profiles included in the particular comfort profile; and generates a set of control element signals which, when executed by a set of control elements included in the vehicle, cause the vehicle to be autonomously navigated along a driving route according to the selected comfort profile, based on a set of driving control parameters included in the selected comfort profile.

Some embodiments provide a method which includes autonomously navigating a vehicle through an environment in which the vehicle is located based on a selected comfort profile. The autonomously navigating includes determining a correlation between a set of detected occupant profiles, generated based on a set of occupants detected within an interior of the vehicle, and a set of occupant profiles included in a comfort profile, wherein the comfort profile includes the set of occupant profiles and a corresponding set of driving control parameters; and causing the vehicle to be autonomously navigated along a driving route according to the comfort profile, based on one or more driving control parameter values included in the corresponding set of driving control parameters.

### BRIEF DESCRIPTION OF THE DRAWINGS

FIG. 1 illustrates a schematic block diagram of a vehicle which comprises an autonomous navigation system (ANS) which is configured to autonomously navigate the vehicle through an environment according to a selected comfort profile, according to some embodiments.

FIG. 2A-B illustrate a block diagram schematic of a vehicle which includes an interior which further includes a set of interior positions in which various occupants can be located, and at least one sensor device which can monitor one or more of the occupants in the vehicle interior, according to some embodiments.

FIG. 3 illustrates a block diagram schematic of a comfort profile database, according to some embodiments.

FIG. 4 illustrates monitoring occupancy of a vehicle interior and generating a comfort profile based on vehicle navigation concurrent with the monitored vehicle occupants, according to some embodiments.

FIG. 5 illustrates autonomously navigating a vehicle according to a selected comfort profile, according to some embodiments.

FIG. 6 illustrates an example computer system configured to implement aspects of a system and method for autonomous navigation, according to some embodiments.

### DETAILED DESCRIPTION

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

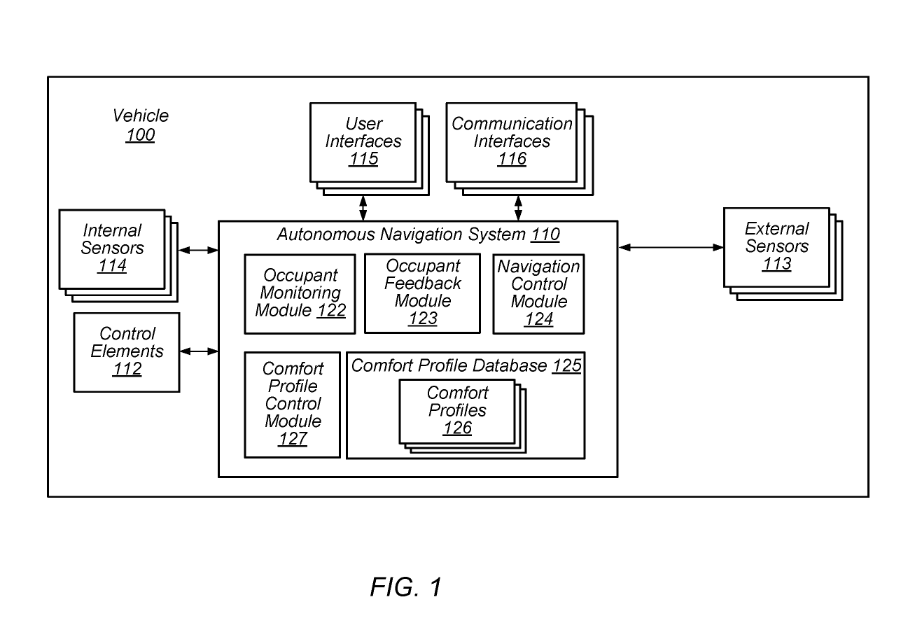

FIG. 1 illustrates a schematic block diagram of a vehicle 100 which comprises an autonomous navigation system (ANS) which is configured to autonomously navigate the vehicle through an environment according to a selected comfort profile, according to some embodiments. The ANS, in some embodiments is configured to autonomously generate autonomous driving control commands which control various control elements of the vehicle to autonomously navigate the vehicle along one or more driving routes.

Vehicle 100 will be understood to encompass one or more vehicles of one or more various configurations which can accommodate one or more occupants, including, without limitation, one or more automobiles, trucks, vans, etc. Vehicle 100 can include one or more interior cabins (“vehicle interiors”) configured to accommodate one or more human occupants (e.g., passengers, drivers, etc.), which are collectively referred to herein as vehicle “occupants”. A vehicle interior may include one or more user interfaces 115, including one or more manual driving control interfaces (e.g., steering device, throttle control device, brake control device), display interfaces, multimedia interfaces, climate control interfaces, some combination thereof, or the like.

Vehicle 100 includes various vehicle control elements 112 which can be controlled, via one or more of the interfaces 115 and the ANS 110, to navigate (“drive”) the vehicle 100 through the world, including navigate the vehicle 100 along one or more driving routes. In some embodiments, one or more control elements 112 are communicatively coupled to one or more user interfaces 115 included in the vehicle 100 interior, such that the vehicle 100 is configured to enable an occupant to interact with one or more user interfaces 115, including one or more manual driving control interfaces, to control at least some of the control elements 112 and manually navigate the vehicle 100 via manual driving control of the vehicle via the manual driving control interfaces 115. For example, vehicle 100 can include, in the vehicle interior, a steering device, throttle device, and brake device which can be interacted with by an occupant to control various control elements 112 to manually navigate the vehicle 100.

Vehicle 100 includes an autonomous navigation system (ANS) 110 which is configured to autonomously generate control element signals which cause the vehicle 100 to be autonomously navigated along a particularly driving route through an environment. In some embodiments, an ANS is implemented by one or more computer systems. ANS 110 is communicatively coupled to at least some of the control elements 112 of the vehicle 100 and is configured to control one or more of the elements 112 to autonomously navigate the vehicle 100. Control of the one or more elements 112 to autonomously navigate the vehicle 100 can include ANS 110 generating one or more control element commands, also referred to herein interchangeably as control element signals.

In some embodiments, ANS 110 generates control element signals which cause one or more sets of control elements 112 to navigate the vehicle 100 through the environment based on input received at ANS 110 via one or more user interfaces 115. For example, ANS 110 can generate control element commands which cause one or more sets of control elements 112 to navigate the vehicle 100 along a particular driving route, based on ANS 110 receiving a user-initiated selection of the particular driving route via one or more interfaces 115.

In some embodiments, ANS 110 autonomously generates control element signals which cause one or more sets of control elements 112 to navigate the vehicle 100 through the environment along a particular driving route. Such control can also referred to as autonomous driving control of the vehicle 100 at the ANS 110. As used herein, autonomous navigation of the vehicle 100 refers to controlled navigation (“driving”) of vehicle 100 along at least a portion of a route based upon autonomous driving control, by ANS 110, of the control elements 112 of the vehicle 100, including steering control elements, throttle control elements, braking control elements, transmission control elements, etc. independently of manual driving control input commands receiving from a user of the vehicle via user interaction with one or more user interfaces 115.

Vehicle 100 includes one or more communication interfaces 116 which are communicatively coupled with ANS 110 and are configured to communicatively couple ANS 110 to one or more remotely located systems, services, devices, etc. via one or more communication networks. For example, an interface 116 can include one or more cellular communication devices, wireless communication transceivers, radio communication interfaces, etc. ANS 110 can be communicatively coupled, via an interface 116, with one or more remote services via one or more wireless communication networks, including a cloud service. ANS 110 can communicate messages to a remote service, system, etc., receive messages from the one or more remote services, systems, etc., and the like via one or more interfaces 116. In some embodiments, communicatively coupling ANS 110 with a remote service, system, etc. via interface 116 includes establishing a two-way communication link between the ANS 110 and the remote service, system, etc. via a communication network to which the interface 116 is communicatively coupled.

Vehicle 100 includes a set of one or more external sensor devices 113, also referred to as external sensors 113, which can monitor one or more aspects of an external environment relative to the vehicle 100. Such sensors can include camera devices, video recording devices, infrared sensor devices, radar devices, depth cameras which can include light-scanning devices including LIDAR devices, precipitation sensor devices, ambient wind sensor devices, ambient temperature sensor devices, position-monitoring devices which can include one or more global navigation satellite system devices (e.g., GPS, BeiDou, DORIS, Galileo, GLONASS, etc.), some combination thereof, or the like. One or more of external sensor devices 113 can generate sensor data associated with an environment as the vehicle 100 navigates through the environment. Sensor data generated by one or more sensor devices 113 can be communicated to ANS 110 as input data, where the input data can be used by the ANS 110, when autonomously navigating the vehicle 100, to generate control element signals which, when executed by control elements 112, cause the vehicle 100 to be navigated along a particular driving route through the environment. In some embodiments, ANS 110 communicates at least some sensor data generated by one or more sensors 113 to one or more remote systems, services, etc. via one or more interfaces 116.

Vehicle 100 includes a set of one or more internal sensors 114, also referred to as sensor devices 114, which can monitor one or more aspects of the vehicle 100 interior. Such sensors can include camera devices, including one or more visible light cameras, infrared cameras, near-infrared cameras, depth cameras which can include light-scanning devices including LIDAR devices, some combination thereof, etc. (including depth cameras, IR cameras) configured to collect image data of one or more occupants in the vehicle interior, control element sensors which monitor operating states of various driving control interfaces 115 of the vehicle, chemical sensors which monitor the atmosphere of the vehicle interior for the presence of one or more chemical substances, some combination thereof, etc. One or more of internal sensor devices 114 can generate sensor data. Sensor data generated by one or more internal sensor devices 114 can be communicated to ANS 110, where the input data can be used by the ANS 110 to monitor the one or more occupants of the vehicle interior, including determining identities of one or more monitored occupants, determining positions of the vehicle interior occupied by one or more monitored occupants, determining one or more occupant properties associated with one or more monitored occupants, etc.

In some embodiments, the ANS 110 can monitor stress levels of one or more occupants based on monitoring one or more observable features of one or more occupants, including one or more of occupant eye movement, occupant body posture, occupant body gestures, occupant pupil dilation, occupant eye blinking, occupant body temperature, occupant heartbeat, occupant perspiration, occupant head position, etc. Based on monitoring a stress level of one or more occupants, also referred to herein as occupant feedback, the ANS 110 can determine adjustments, also referred to herein as updates, of one or more comfort profiles according to which the ANS 110 can generate control element signals to cause control elements 112 to navigate the vehicle 100 along a particular driving route.

ANS 110 includes a navigation control module 124 which is configured to generate control element signals, which can be executed by particular control elements 112 to cause the vehicle 100 to be navigated along a particular driving route, based on sensor data received from external sensors 113. In some embodiments, module 124 generates control element signals which cause the vehicle 100 to be navigated according to a selected comfort profile. For example, the module 124 can generate control element signals which, when executed by one or more control elements, cause vehicle 100 to be turned to navigate through a turn through an intersection, where the control element signals cause the vehicle to be turned at a particular rate based on a value of a turning rate driving control parameter included in the selected comfort profile. As a result, based on the driving control parameters included in a selected comfort profile, module 124 is configured to navigate the vehicle 100 according to a driving “style” which corresponds to a selected comfort profile. Generating control element commands based on driving control parameters of a comfort profile can be referred to as navigating a vehicle according to a driving “style” specified by the parameter values of the various driving control parameters included in a selected comfort profile. As is discussed further below, the comfort profile can be selected based on the occupancy of the vehicle 100, so that the driving “style” via which the vehicle 100 is navigated by module 124 provides a personalized driving experience which is tailored to the specific occupancy of the vehicle, including the identities, occupant types, positions, and monitored feedback of the occupants.

ANS 110 includes an occupant monitoring module 122 which is configured to monitor one or more occupants of an interior of vehicle 100 based on processing sensor data generated by one or more internal sensors 114. Module 122 can, based on monitoring one or more occupants of a vehicle interior, determine one or more of a position of an occupant within the vehicle interior, an identity of an occupant, a particular occupant type of an occupant, etc. Module 122 can determine an occupant identity based on facial recognition, which can include comparing one or more monitored features of a monitored occupant's face with a set of stored facial recognition data associated with a particular known occupant identity and determining a correlation between the monitored features and the stored facial recognition data associated with the known occupant identity. Module 122 can determine an occupant type of an occupant, which can include one or more of a human adult occupant, a human occupant associated with a particular age range, an animal, a human male occupant, a human female occupant, some combination thereof, etc., based on correlating a sensor data representations of the occupant with one or more sets of stored occupant type data associated with one or more particular occupant types. As used herein, a sensor data representation of an occupant can include a captured image of one or more portions of the occupant.

Users can benefit from use of data associated with a known occupant identity. For example, the personal data can be used to determine a comfort profile via which to navigate a vehicle based on detecting an occupant and determining a comfort profile associated with the detected occupant. Accordingly, use of such personal data enables users to influence and control how a vehicle is navigated.

Users, which can include occupants, can selectively block use of, or access to, personal data. A system incorporating some or all of the technologies described herein can include hardware and/or software that prevents or blocks access to such personal data. For example, the system can allow users to “opt in” or “opt out” of participation in the collection of personal data or portions of portions thereof. Also, users can select not to provide location information, or permit provision of general location information (e.g., a geographic region or zone), but not precise location information.

Entities responsible for the collection, analysis, disclosure, transfer, storage, or other use of such personal data should comply with established privacy policies and/or practices. Such entities should safeguard and secure access to such personal data and ensure that others with access to the personal data also comply. Such entities should implement privacy policies and practices that meet or exceed industry or governmental requirements for maintaining the privacy and security of personal data. For example, an entity should collect users' personal data for legitimate and reasonable uses, and not share or sell the data outside of those legitimate uses. Such collection should occur only after receiving the users' informed consent. Furthermore, third parties can evaluate these entities to certify their adherence to established privacy policies and practices.

Module 122 can generate a set of detected occupant profiles based on monitoring occupants in a vehicle interior, where each occupant profile corresponds to a particular separate detected occupant and includes various aspects of the detected occupant which are determined based on processing sensor data representations of the occupant. For example, where module 122 determines, based on processing sensor data, a position and occupant type of an occupant in the vehicle interior, module 122 can generate an occupant profile which corresponds to the detected occupant and which includes the determined occupant position and occupant type of the detected occupant. A position of an occupant in the vehicle interior can include a particular seat, included in the vehicle interior, in which the occupant is seated.

ANS 110 includes an occupant feedback module 123 which is configured to determine, based on monitoring one or more occupants of the vehicle interior via processing sensor data generated by one or more internal sensors 114, an occupant stress level, of one or more occupants, with regard to the present driving “style” via which the vehicle is presently being navigated. The feedback module 123 can determine occupant stress level with regard to a driving style via which the vehicle is presently being manually navigated, autonomously navigated, some combination thereof, etc. Where a vehicle is being autonomously navigated according to a selected comfort profile, feedback module 123 can update the selected comfort profile, which can include adjusting one or more parameter values of one or more driving control parameters included in the selected comfort profile, based on monitoring occupant stress levels concurrent the vehicle being navigated according to the selected comfort profile.

For example, where module 124 causes vehicle 100 to be navigated according to a particular selected comfort profile, and module 123 determines that one or more occupants of the vehicle 100 are associated with an elevated stress level concurrently with one or more particular navigations of the vehicle according to the selected comfort profile, module 123 can update the one or more particular driving control parameters of the selected comfort profile based upon which the one or more particular navigations are executed via control element signals generated by module 124.

Module 123 is configured to update one or more driving control parameters of a comfort profile in a manner which is configured to reduce a stress level, which can include a determined unease, unhappiness, dissatisfaction, disconcertion, discomfort, some combination thereof, etc., of an occupant. For example, where a vehicle makes a turn at a certain rate, based on a driving control parameter of a selected comfort profile which specifies a maximum turning rate value, and module 123 determines that an occupant of the vehicle is associated with an elevated stress level concurrently with the vehicle being navigated along the turn, module 123 can, in response, update the selected comfort profile such that the turn rate driving control parameter is reduced from the maximum value to a reduced value. Where a monitored occupant is determined to be associated with a lower stress level, where the vehicle is being navigated autonomously by module 124 according to a selected comfort profile, module 123 can refrain from updating the selected comfort profile.

ANS 110 includes a comfort profile database 125 which includes a set of comfort profiles 126 which are generated based on monitoring navigation of a vehicle and occupancy of the vehicle concurrent with the navigation. ANS 110 includes a comfort profile control module 127 which generates comfort profiles, selects comfort profiles via which the vehicle 100 is navigated, executes updates to one or more comfort profiles, some combination thereof, etc. The module 127 can monitor manual navigation of the vehicle 100 by a particular occupant, alone or with one or more additional occupants in one or more positions in the vehicle interior, and can further generate a comfort profile 125 which associates a set of occupant profiles, generated based on the monitored occupancy of the vehicle, with a set of driving control parameters which collectively specify a driving “style” via which a vehicle can be navigated according to the style via which the vehicle is being manually navigated concurrently with the monitored occupancy of the vehicle.

For example, where a particular identified occupant is monitored to navigate vehicle 100 at a maximum turning rate, minimum turning radius, maximum acceleration rate, etc. when manually navigating vehicle 100 in the absence of any additional occupants of the vehicle, module 127 can generate a particular profile 126 which associates an occupant profile which specifies one or more aspects of the particular identified occupant in the vehicle with a set of driving control parameters which specify a driving style which includes navigating the vehicle with maximum acceleration, minimum turning radius, maximum turning rate, etc.

In another example, where a particular identified occupant is monitored to navigate vehicle 100 at a minimum acceleration rate and maximum turning radio when manually navigating vehicle 100 with an unidentified occupant associated with a human occupant type associated with a particular age range in a front passenger seat, module 127 can generate a particular profile 126 which associates a set of occupant profiles which each separately specify determined aspects of the identified occupant and a human occupant associated with a particular age range in at least one position of the vehicle interior with a set of driving control parameters which specify a driving style which includes navigating the vehicle with minimum acceleration, maximum turning radius, etc.

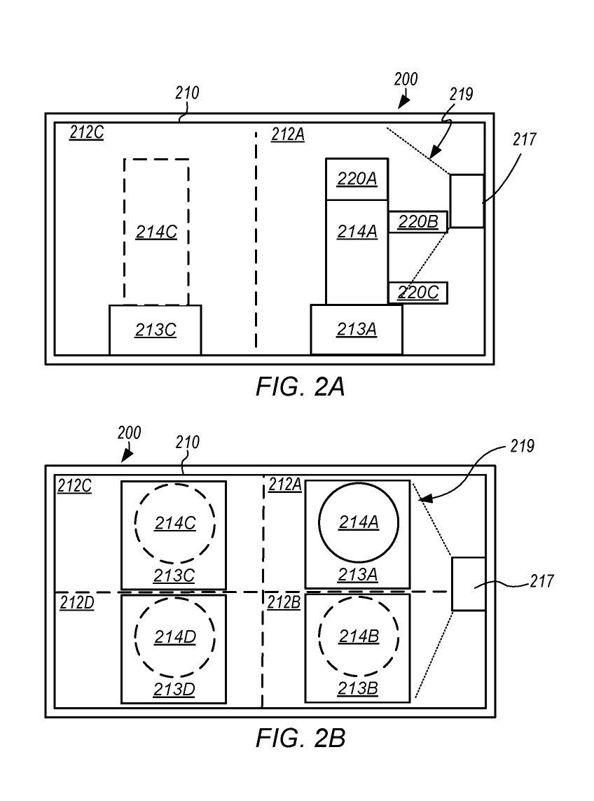

FIG. 2A-B illustrate a block diagram schematic of a vehicle 200 which includes an interior 210 which further includes a set of interior positions in which various occupants can be located, and at least one sensor device which can monitor one or more of the occupants in the vehicle interior, according to some embodiments. The vehicle 200 illustrated in FIG. 2A-B can be included in any of the embodiments herein, including the vehicle 100 shown in FIG. 1.

Vehicle 200 includes an interior 210 which includes various interior positions 212A-D. Each separate interior position 212A-D includes a separate seat 213A-D in which one or more occupants 214A-D can be located.

Vehicle 200 further includes at least one internal sensor device 217 which is configured to monitor at least a portion of the vehicle interior 210 which is encompassed within a field of view 219 of the sensor device 217. As shown, where an occupant 214A includes multiple separate body parts 220A-C which are located within the field of view 219 of the internal sensor 217, the sensor can generate sensor data representations of some or all of the occupant 214A, including sensor data representations of one or more of the body parts 220A-C of the occupant. The sensor data representations can be processed by one or more portions of an ANS included in the vehicle 200, including one or more monitoring modules, comfort profile modules, feedback modules, etc.

As shown, an internal sensor device 217 included in vehicle 200 can monitor multiple occupants located in multiple various positions of the interior. As a result, sensor data generated by the sensor device 217 can be utilized by one or more portions of an ANS included in the vehicle 200 to monitor one or more aspects of the multiple occupants in the multiple positions in the interior 210, generate a comfort profile based on the monitored occupants, select a particular comfort profile according to which the ANS can autonomously navigate the vehicle 200 based on the monitored occupants, update a selected comfort profile based on monitoring one or more aspects of the monitored occupants, etc. In some embodiments, monitoring occupants of a vehicle includes determining an absence of occupants in one or more positions of the interior. For example, as shown, occupants 214B-D are absent from positions 212B-D, so that an ANS included in vehicle 200, monitoring the interior 210 via sensor data representations of the field of view 219 of sensor device 217, can determine that occupant 214A occupies position 212A and is alone in the interior 210.

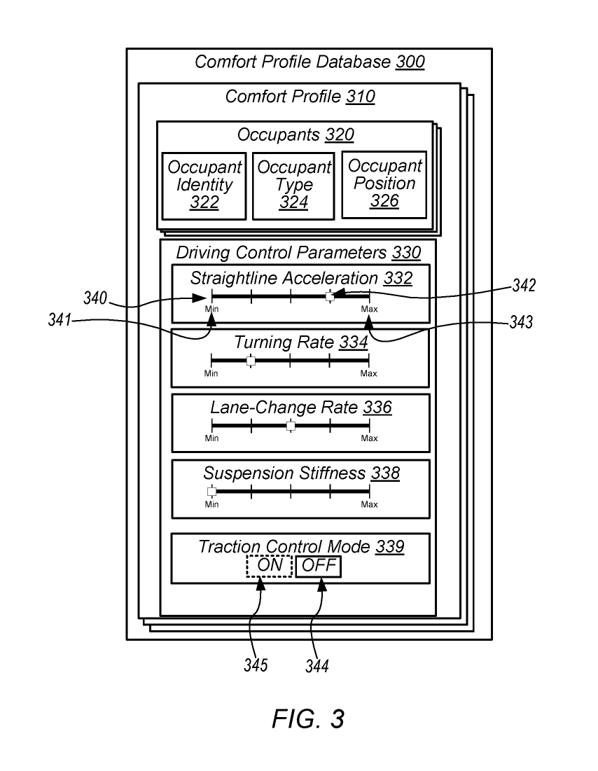

FIG. 3 illustrates a block diagram schematic of a comfort profile database, according to some embodiments. The comfort profile database 300 illustrated in FIG. 3 can be included in any of the embodiments of comfort profile modules included herein, including the comfort profile module 125 shown in FIG. 1.

As shown, database 300 includes a set of comfort profiles 310 which each associate a particular driving style, specified by various driving control parameters which each specify various particular parameter values, with a particular occupancy of a vehicle, specified by various occupant profiles which each specify aspects of a separate occupant of the vehicle interior.

As referred to herein, a specified driving style includes a set of driving control parameters, each specifying a separate parameter value, which collectively specify a style via which a vehicle is to be navigated. A navigation control module which autonomously navigates a vehicle according to a comfort profile can generate control element commands which cause the vehicle to be navigated along a driving route according to the various parameter values of the various driving control parameters included in the comfort profile, such that the vehicle is navigated according to the “driving style” specified by the comfort profile.

The occupancy specified by the comfort profile indicates a particular occupancy of the vehicle for which the comfort profile is to be selected, so that a particular comfort profile which specifies a particular occupancy of a vehicle is selected when a set of detected occupant profiles, generated based on monitoring a set of occupants detected in a vehicle interior, at least partially matches the occupancy specified by the set of occupant profiles included in the comfort profile.

As shown, each comfort profile 310 includes a set of occupant profiles 320 which each specify a separate occupant and each specify one or more aspects, also referred to herein as parameters, which are associated with the respective separate occupant. The profile 310 is selected for use by the navigation control system of a vehicle, so that the navigation control system generates navigates the vehicle according to the driving control parameters 330 of the given profile 310, when a set of detected occupant profiles, generated based on monitoring one or more aspects of occupants detected in a vehicle interior, at least partially matches the set of occupant profiles 320 of the profile 310. Each occupant profile 320 can include a specification of one or more aspects of a separate occupant, including the position 326 of the vehicle interior in which the occupant 320 is located, an occupant type 324 associated with the occupant, and an occupant identity 322 associated with the occupant.

An occupant profile 320 can include a limited selection of occupant parameters 322, 324, 326 which are generated based on monitoring a particular occupant in a vehicle interior. For example, a profile 310 can include an associated occupant profile 320 which specifies an occupant having a particular identity 322 and being located in a particular position 326 in the vehicle interior which corresponds to a driver position in the vehicle interior. The profile can include another associated occupant profile 320 which specifies an occupant associated with a particular occupant type 324 of a human occupant associated with a particular age range and being located in a particular position 326 in the vehicle interior which corresponds to a front-passenger position in the vehicle interior. As a result, profile 310 is associated with an occupancy which includes a particular occupant, having a particular identity, being located in the driver position of the vehicle and a human occupant associated with a particular age range being located in the front passenger position of the vehicle. Therefore, the given profile 310 can be selected for utilization by the navigation control system in navigating the vehicle according to the specified driving control parameters 330 of the given profile 310 based on a determination that the present occupants of the vehicle includes an occupant with the particular identity in the driver position and a human occupant associated with a particular age range in the front passenger position. Such a determination can be based on comparing the profiles 320 with a set of detected occupant profiles generated based on monitoring occupants of the vehicle interior and determining that the profiles 320 match at least a portion of the set of detected occupant profiles.

In some embodiments, the occupant profiles 320 are restrictive, such that a given profile is selected upon a determination that the set of detected occupant profiles, generated based on monitoring the present occupancy of the vehicle, exactly matches the occupant profiles 320 of the profile 310. For example, where the profiles 320 of a given profile 310 include two profiles 320, where the first profile 320 specifies that an occupant having a particular identity 322 is located in the driver position 326 of the interior and the second profile 320 specifies that an occupant associated with a particular occupant type 324 is located in the front passenger position 326, the profile 310 may not be selected for use by the navigation control system in response to a determination that the set of detected occupant profiles, generated based on monitoring the present occupancy of the vehicle includes a profile specifying an occupant having the particular identity located in the driver position of the interior, another profile specifying an occupant having the particular occupant type located in the front passenger position, and another profile specifying an occupant located in a rear passenger position. In some embodiments, a given profile 310 is selected based on a determination that the occupants specified by the set of profiles 320 associated with the profile 310 match at least some of the set of detected occupant profiles specifying the monitored occupants of the vehicle.

As shown, each comfort profile 310 includes a set of driving control parameters 330 which specify various parameters via which a vehicle is to be navigated, when the vehicle is navigated according to the profile 310.

As shown, the parameters 330 include vehicle straight-line acceleration rate 332, vehicle turning rate 334, vehicle lane-change rate 336, vehicle suspension stiffness 338, and vehicle traction control mode 339. When profile 310 is selected, the navigation control system included in a vehicle generates control element commands which command control elements in the vehicle to navigate the vehicle according to the parameter values 342 of some or all of the parameters 330. For example, where the navigation control system generates a control element command which controls a throttle control element of the vehicle to cause the vehicle to accelerate, the navigation control system generates the control element command to cause the throttle control element to cause the vehicle to accelerate at a rate which is determined based on the value 342 of the vehicle straight-line acceleration parameter 332.

As shown, each of parameters 332-338 include parameter values 342 which are adjustable on a scale 340 between relative minimum 341 and maximum 343 values. The minimum and maximum values can be associated with structural bounds on the driving control parameter, safety bounds, etc. For example, the maximum value 343 for the straight-line acceleration 332 scale 340 can be associated with a maximum safe acceleration rate which can be achieved by the control elements of the vehicle, and the minimum value 342 can be associated with a predetermined minimum acceleration rate of the vehicle.

As shown, parameter 339 includes binary values 344-345, where one of the values 344-345 is active at any given time. As shown, parameter 339 specifies the state of traction control of the vehicle, where value 344 is active and value 345 is inactive, thereby specifying that traction control is disabled when a vehicle is navigated according to the driving control parameters 330 of the given profile 310.

As shown, each separate parameter 332-339 includes a specification of a particular parameter value. The illustrated parameters are specified qualitatively, where the parameter 339 is specified as a binary state and parameters 332-338 are specified as a relative value 342 on a scale 340 between two determined extremes 341, 343, where the extremes can be based on one or more properties of one or more safety boundaries, control element operating constraints, vehicle navigation constraints, etc. In some embodiments, one or more driving control parameter values include one or more specified quantitative values. For example, a straight-line acceleration parameter 332, in some embodiments, includes a quantitative specification of a target acceleration rate at which the vehicle being navigated according to profile 310 is to be accelerated.

In some embodiments, generation of a profile 310 includes detecting one or more occupants of a vehicle interior and generating separate profiles 320 for each occupant, where one or more of the identity 322, occupant type 324, occupant position 326, etc. is determined and included in a profile for a given detected occupant, based on processing sensor data representations of the vehicle interior. The navigation of the vehicle concurrently with the presence of the detected occupants represented by the generated profiles can be monitored, and one or more driving control parameter 330 values can be determined based on monitoring the navigation of the vehicle. As a result, a set of parameters 330, each including parameter values determined based on monitoring navigation of the vehicle, are generated and associated with the set of profiles 320 of the occupants which are present in the vehicle concurrently with the navigation of the vehicle upon which the parameter 330 values are determined. The generated occupant profiles 320 and the generated parameters 330 can be included in a profile 310 which specifies the that a vehicle is to be navigated according to the values of the parameters 330 included in the profile 310 when occupant profiles of occupants detected in the vehicle at least partially match the occupant profiles 320 included in the profile 310.

One or more aspects of a profile 310 can be revised, updated, etc. over time, based on successive navigations of a vehicle when the detected occupant profiles of the vehicle match the occupant profiles 320 included in the comfort profile 320. Where the vehicle is manually navigated in a different driving style than the style specified by the driving control parameters 330 included in the profile 310, when the detected occupant profiles of the vehicle match the occupant profiles 320 included in the comfort profile, the values of the various parameters 330 can be adjusted based on the driving style via which the vehicle is being manually navigated. Where the vehicle is autonomously navigated according to the driving style specified by the parameters 330 of profile 310, and the occupants of the vehicle are determined, based on processing interior sensor data, to be experiencing elevated stress levels concurrently with the autonomous navigation, one or more parameter 330 values can be adjusted via a feedback loop with the monitored stress level of one or more of the occupants, so that one or more parameter values 330 are adjusted to levels which correspond to reduced determined stress level, minimum determined stress level, etc. of the one or more occupants.

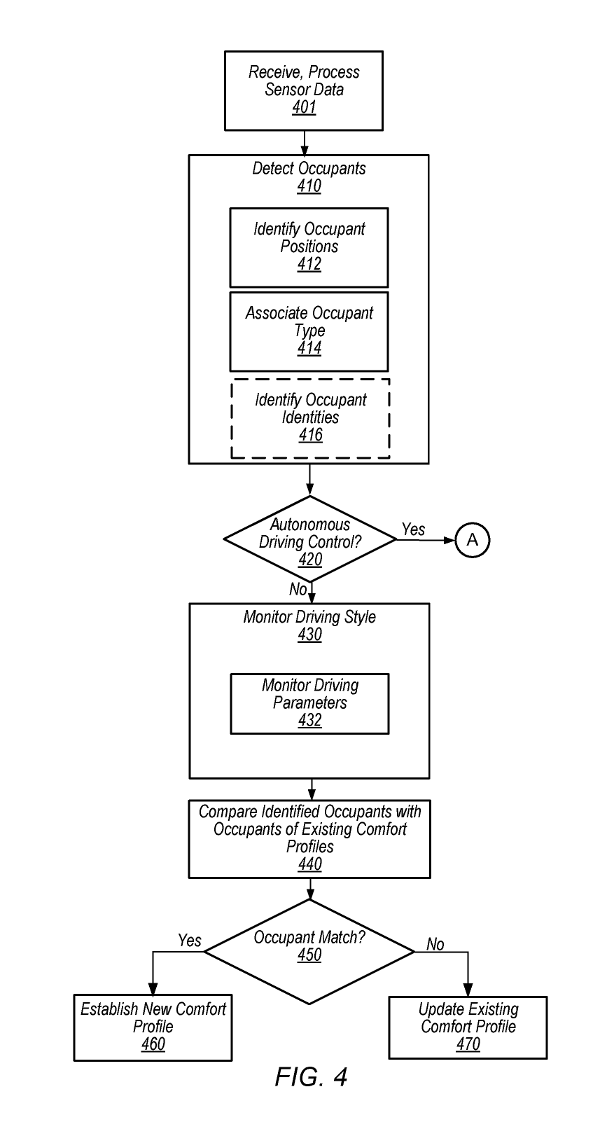

FIG. 4 illustrates monitoring occupancy of a vehicle interior and generating a comfort profile based on vehicle navigation concurrent with the monitored vehicle occupants, according to some embodiments. The monitoring and generating can be implemented by one or more portions of any embodiments of an ANS included herein, and the one or more portions of the ANS can be implemented by one or more computer systems.

At 401, one or more instances of sensor data, generated by one or more sensor devices included in a vehicle, are received and processed at the ANS. Sensor data can be received from multiple different sensor devices. Sensor data can include images captured by one or more camera devices, chemical substance data indicating a presence and concentration of chemical substances in the vehicle interior, some combination thereof, etc. Sensor data can include vehicle sensor data indicating a state of one or more control elements included in the vehicle, a state of one or more portions of the vehicle, etc. Sensor data can include external sensor data which sensor data representations of one or more portions of an external environment in which the vehicle is located. Sensor data can include internal sensor data which includes sensor data representations of one or more portions of the vehicle interior. Sensor data representations of an environment, interior, etc. can include captured images of the environment, interior, etc.

At 410, based on processing sensor data at 401, one or more occupants located in the vehicle interior are detected. As shown, identifying one or more given occupants includes, for each occupant, identifying one or more aspects of the given occupant, including a position 412 of the vehicle interior occupied by the given occupant, associating an occupant type 414 with the occupant. In some embodiments, detecting an occupant includes identifying a particular occupant identity 416 of the occupant. Identifying a position 412 of the vehicle interior occupied by the given occupant can include determining a position of the interior in which the occupant is located. Identifying an occupant type 414 associated with the occupant can include determining, based on processing sensor data representations of the occupant, that the representation of the occupant corresponds with one or more sensor data representations associated with a particular occupant type. Identifying an occupant identity of a detected occupant can include determining, based on processing sensor data representations of the detected occupant, that one or more representations of the occupant correspond to sensor data representation data associated with a particular user profile associated with a particular user identity. One or more of an occupant identity, occupant type, etc. can be determined based on one or more of facial recognition processes.

Detecting an occupant can include generating a detected occupant profile associated with the detected occupant. The detected occupant profile can include the identified occupant position 412 of the occupant, an occupant type 414 determined to correspond to sensor data representations of the occupant, a determined occupant identity 416 of the occupant, some combination thereof, etc.

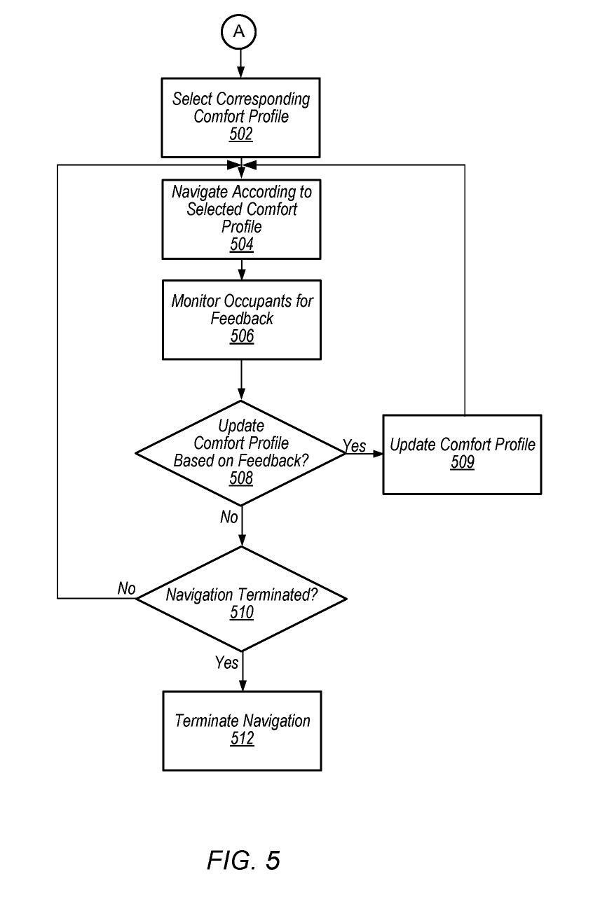

At 420, a determination is made regarding whether the vehicle is being navigated via autonomous driving control. If so, the vehicle is autonomously navigated according to one or more comfort profiles, as shown and discussed further with regard to FIG. 5. If not, as shown at 430, the driving style via which the vehicle is manually navigated is monitored concurrently with the presence of the detected occupants in the vehicle.

As shown, the monitoring at 430 includes monitoring 432 one or more particular driving control parameters which specify one or more aspects of navigating the vehicle. For example, where a monitored driving control parameter includes a turning radius via which the vehicle is navigated when turning right at an intersection, the monitoring at 432 includes monitoring the turning radius via which the vehicle is manually navigated when the vehicle is manually navigated through a right turn at an intersection. The monitoring at 432 can be implemented via processing sensor data generated by one or more sensor devices of the vehicle, including geographic position sensors, accelerometers, wheel rotation sensors, steering control element sensors, etc. The monitoring can include generating a set of driving control parameters associated with the navigation, where the generating includes assigning parameter values to one or more various driving control parameters in the set based on monitoring the navigation of the vehicle through an environment.

At 440 and 450, a determination is made regarding whether the detected occupancy, at 410, of the vehicle concurrently with the vehicle being navigated according to the driving style monitored at 430, corresponds to an occupancy associated with a pre-existing comfort profile. If not, as shown at 460, a new comfort profile is generated, where the new comfort profile includes occupant profiles associated with the detected occupants at 410 and driving control parameters associated with the monitored driving style at 430. If so, as shown at 470, the existing comfort profile is updated based on the monitored driving style, which can include one or more of adjusting, revising, replacing, etc. one or more parameter values of one or more of the driving control parameters included in the comfort profile, so that the comfort profile represents an updated representation of a driving style via which the vehicle is navigated when the occupancy of the vehicle matches the occupant entries of the existing comfort profile.

FIG. 5 illustrates autonomously navigating a vehicle according to a selected comfort profile, according to some embodiments. The autonomous navigating can be implemented by one or more portions of any embodiments of an ANS included herein, and the one or more portions of the ANS can be implemented by one or more computer systems.

At 502, based on a determination, at 420 in FIG. 4, that autonomous navigation of a vehicle which includes the occupants detected at 410 is commanded, a comfort profile which includes occupant profiles that correspond to the detected occupant profiles generated based on the detected occupants of the vehicle at 410 is selected. Selecting a comfort profile can include comparing the set of detected occupant profiles associated with the detected occupants with a set of occupant entries included in a comfort profile. Matching occupant profiles can include determining that separate occupant profiles, in separate sets of occupant profiles, each include common occupant profiles. Based on a determination that the set of occupant profiles included in a comfort profile at least partially matches a set of occupant profiles associated with the detected occupants, the comfort profile is selected. Where the set of occupant profiles associated with the detected occupants does not completely match a set of occupant profiles included in any comfort profiles, a comfort profile can be selected where the occupant profiles of the selected comfort profile correlate with the occupant profiles of the detected occupants to a greater level than any other sets of occupant profiles of any other comfort profiles.

At 504, the vehicle is navigated along one or more driving routes according to the selected comfort profile. Navigating a vehicle according to a selected comfort profile includes generating control element commands which cause control elements of a vehicle to navigate the vehicle along a driving route in conformance to one or more driving control parameters included in the selected comfort profile. For example, where a control element command is generated to cause a steering control element to turn the vehicle to the right at an intersection to navigate the vehicle along a driving route, navigating the vehicle according to a comfort profile which includes a driving control parameter which specifies a turning radius can include generating a control element command where the control element command causes the steering control element to turn the vehicle to the right along the specified turning radius.

At 506, the occupants of the vehicle are monitored, via processing sensor data generated by one or more sensor devices, for indications of feedback with regard to the navigating at 504. The monitoring can include determining whether one or more of the occupants is determined to be associated with elevated stress levels concurrently with the navigation of the vehicle according to the selected comfort profile. For example, where the navigating at 504 includes generating control element commands which cause a throttle device of the vehicle to accelerate the vehicle at a rate which is determined based on an acceleration driving control parameter of the selected comfort profile, the monitoring at 506 can include monitoring one or more of the occupants for indications of elevated stress concurrently with the acceleration.

Determining a stress level of an occupant, including determining an elevated stress level, can be based on processing sensor data representations of an occupant can comparing one or more aspects of the representation with stored representations which are associated with various stress levels. For example, where a detected occupant is determined, based on processing a sensor data representation of the occupant, to be exhibiting a particular body posture, the detected body posture can be compared with a set of body postures which are each associated with one or more various stress levels. Based on a match of the detected body posture with a stored body posture representation which is associated with a particular stress level, the particular occupant can be determined to be exhibiting the particular stress level. Stress levels can include one or more levels on a scale between a minimum stress level and a maximum stress level, and an elevated stress level can include a stress level which is greater than an average stress level on the scale, a median stress level on the scale, some combination thereof, etc.

In response to detection of elevated occupant stress levels concurrently with navigating the vehicle according to one or more particular driving control parameters of the selected comfort profile, the one or more particular driving control parameters can be updated based on the detection. For example, where elevated stress associated with an occupant concurrently with accelerating the vehicle according to an acceleration driving control parameter of the selected comfort profile is detected, via sensor data processing, the acceleration driving control parameter can be updated to specify a reduced level of acceleration, such that navigating the vehicle according to the updated acceleration driving control parameter includes accelerating the vehicle at a reduced rate which is determined based on the specified reduced level of acceleration in the acceleration driving control parameter.

At 508, a determination is made regarding whether updates to the comfort profile can be made based on occupant feedback determined at 506. If so, as shown at 509, the comfort profile is updated accordingly. If not, at 510 and 512, the navigation is continued until a determination is made that autonomous navigation is to be terminated, upon which the autonomous navigation is terminated. The determination at 510 can be made based on occupant interaction with one or more interfaces included in the vehicle, a determination that the vehicle has completed navigation along a driving route and that no additional driving routes are selected, etc.

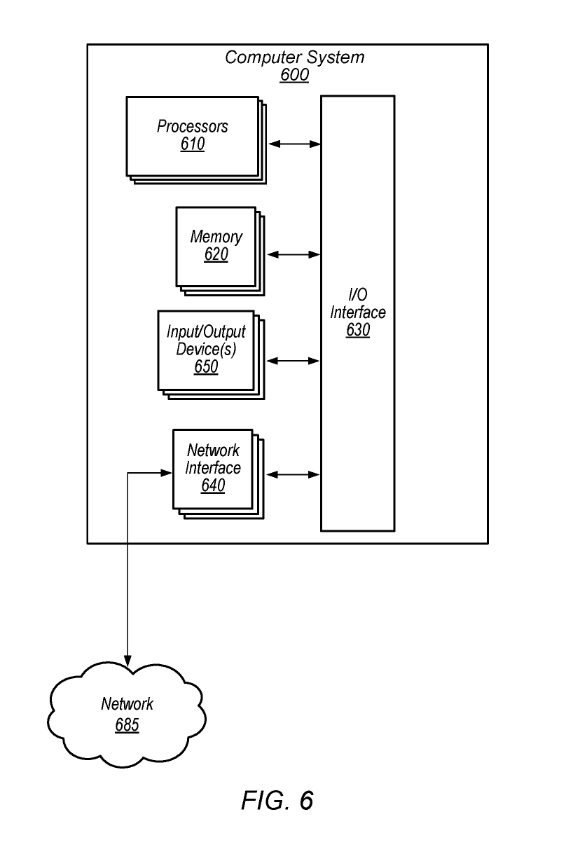

FIG. 6 illustrates an example computer system 600 that may be configured to include or execute any or all of the embodiments described above. In different embodiments, computer system 600 may be any of various types of devices, including, but not limited to, a personal computer system, desktop computer, laptop, notebook, tablet, slate, pad, or netbook computer, cell phone, smartphone, PDA, portable media device, mainframe computer system, handheld computer, workstation, network computer, a camera or video camera, a set top box, a mobile device, a consumer device, video game console, handheld video game device, application server, storage device, a television, a video recording device, a peripheral device such as a switch, modem, router, or in general any type of computing or electronic device.

Various embodiments of an autonomous navigation system (ANS), as described herein, may be executed in one or more computer systems 600, which may interact with various other devices. Note that any component, action, or functionality described above with respect to FIG. 1 through 5 may be implemented on one or more computers configured as computer system 600 of FIG. 6, according to various embodiments. In the illustrated embodiment, computer system 600 includes one or more processors 610 coupled to a system memory 620 via an input/output (I/O) interface 630. Computer system 600 further includes a network interface 640 coupled to I/O interface 630, and one or more input/output devices, which can include one or more user interface devices. In some cases, it is contemplated that embodiments may be implemented using a single instance of computer system 600, while in other embodiments multiple such systems, or multiple nodes making up computer system 600, may be configured to host different portions or instances of embodiments. For example, in one embodiment some elements may be implemented via one or more nodes of computer system 600 that are distinct from those nodes implementing other elements.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs), such as the x86, PowerPC, SPARC, or MIPS ISAs, or any other suitable ISA. In multiprocessor systems, each of processors 610 may commonly, but not necessarily, implement the same ISA.

System memory 620 may be configured to store program instructions, data, etc. accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions included in memory 620 may be configured to implement some or all of an automotive climate control system incorporating any of the functionality described above. Additionally, existing automotive component control data of memory 620 may include any of the information or data structures described above. In some embodiments, program instructions and/or data may be received, sent or stored upon different types of computer-accessible media or on similar media separate from system memory 620 or computer system 600. While computer system 600 is described as implementing the functionality of functional blocks of previous Figures, any of the functionality described herein may be implemented via such a computer system.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network 685 (e.g., carrier or agent devices) or between nodes of computer system 600. Network 685 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices may, in some embodiments, include one or more display terminals, keyboards, keypads, touchpads, scanning devices, voice or optical recognition devices, or any other devices suitable for entering or accessing data by one or more computer systems 600. Multiple input/output devices may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

Memory 620 may include program instructions, which may be processor-executable to implement any element or action described above. In one embodiment, the program instructions may implement the methods described above. In other embodiments, different elements and data may be included. Note that data may include any data or information described above.

Those skilled in the art will appreciate that computer system 600 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. An apparatus, comprising:
an autonomous navigation system configured to be installed in a vehicle and autonomously navigate the vehicle through an environment in which the vehicle is located based on a selected comfort profile, wherein the autonomous navigation system is configured to:
select a comfort profile, from a set of comfort profiles, based on a determined correlation between a set of detected occupant profiles, generated based on a set of occupants detected within an interior of the vehicle, and a set of occupant profiles associated with the particular comfort profile; and
generate a set of control element signals which, when executed by a set of control elements included in the vehicle, cause the vehicle to be autonomously navigated along a driving route according to the selected comfort profile, based on a set of driving control parameters included in the selected comfort profile.

2. The apparatus of claim 1, wherein:
at least one occupant profile included in the set of occupant profiles associated with the particular comfort profiles specifies one or more characteristics of a particular occupant located in a vehicle which is navigated according to the comfort profile in which the set of occupant profiles is included; and
the autonomous navigation system is configured to determine a correlation between the set of detected occupant profiles and the set of occupant profiles associated with the particular comfort profile based on a determined correlation between aspects specified by the set of detected occupant profiles and aspects specified by the set of occupant profiles included in the particular comfort profile.

3. The apparatus of claim 2, wherein the one or more characteristics specified by the at least one occupant profile comprises at least one of:
a specification of an occupant type of the particular occupant;
a specification of a position within the vehicle occupied by the particular occupant; and
a specification of an occupant identity of the particular occupant.

4. The apparatus of claim 1, wherein:
the set of driving control parameters included in the selected comfort profile specify a set of target parameter values via which the vehicle is navigated.

5. The apparatus of claim 4, wherein the parameter values via which the vehicle is navigated comprise at least one of:
an acceleration rate value which specifies a target rate at which the set of control element signals can cause the set of control elements included in the vehicle to accelerate the vehicle;
a turning rate value which specifies a target rate at which the set of control element signals can cause the set of control elements included in the vehicle to turn the vehicle;
a lane change rate value which specifies a target rate at which the set of control element signals can cause the set of control elements included in the vehicle to cause the vehicle to change between separate roadway lanes; and
a suspension stiffness value which specifies a target stiffness of the suspension at which the set of control element signals can cause the set of control elements included in the vehicle to adjust the suspension stiffness.

6. The apparatus of claim 4, wherein:
at least one of the target parameter values is adjustable on a corresponding scale between a relative minimum value and a relative maximum value.

7. The apparatus of claim 6, wherein the autonomous navigation system is configured to:
monitor a stress level of one or more of the detected occupants, based on processing sensor data generated by one or more sensor devices installed in the vehicle; and
adjust a value of at least one of the target parameter values along the corresponding scale based on monitoring the stress level of the one or more of the detected occupants.

8. A method, comprising:
autonomously navigating a vehicle through an environment in which the vehicle is located based on a selected comfort profile, wherein the autonomously navigating comprises:
determining a correlation between a set of detected occupant profiles, generated based on a set of occupants detected within an interior of the vehicle, and a set of occupant profiles associated with a comfort profile, wherein the comfort profile includes a corresponding set of driving control parameters associated with the set of occupant profiles; and
causing the vehicle to be autonomously navigated along a driving route according to the comfort profile, based on one or more driving control parameter values included in the corresponding set of driving control parameters.

9. The method of claim 8, wherein:
at least one occupant profile included in the set of occupant profiles included in the particular comfort profiles specifies one or more aspects of a particular occupant located in a vehicle which is navigated according to the comfort profile in which the set of occupant profiles is included; and
the method comprises determining a correlation between the set of detected occupant profiles and the set of occupant profiles included in the particular comfort profile based on a determined correlation between aspects specified by the set of detected occupant profiles and aspects specified by the set of occupant profiles included in the particular comfort profile.

10. The method of claim 9, wherein the one or more aspects specified by the at least one occupant profile comprises at least one of:
a specification of an occupant type of the particular occupant;
a specification of a position within the vehicle occupied by the particular occupant; and
a specification of an occupant identity of the particular occupant.

11. The method of claim 8, wherein:
the set of driving control parameters included in the selected comfort profile specify a set of target parameter values via which the vehicle is navigated.

12. The method of claim 11, wherein the parameter values via which the vehicle is navigated comprise at least one of:
an acceleration rate value which specifies a target rate at which the set of control element signals can cause the set of control elements included in the vehicle to accelerate the vehicle;
a turning rate value which specifies a target rate at which the set of control element signals can cause the set of control elements included in the vehicle to turn the vehicle;
a lane change rate value which specifies a target rate at which the set of control element signals can cause the set of control elements included in the vehicle to cause the vehicle to change between separate roadway lanes; and
a suspension stiffness value which specifies a target stiffness of the suspension at which the set of control element signals can cause the set of control elements included in the vehicle to adjust the suspension stiffness.

13. The method of claim 11, wherein:
at least one of the target parameter values is adjustable on a corresponding scale between a relative minimum value and a relative maximum value.

14. The method of claim 13, comprising:
monitoring a stress level of one or more of the detected occupants, based on processing sensor data generated by one or more sensor devices installed in the vehicle; and
adjusting a value of at least one of the target parameter values along the corresponding scale based on monitoring the stress level of the one or more of the detected occupants.

15. A non-transitory, computer-readable medium storing a program of instructions which, when executed by at least one computer system, causes the at least one computer system to:
autonomously navigate a vehicle through an environment in which the vehicle is located based on a selected comfort profile, wherein the autonomously navigating comprises:
determining a correlation between a set of detected occupant profiles, generated based on a set of occupants detected within an interior of the vehicle, and a set of occupant profiles included in a comfort profile, wherein the comfort profile includes the set of occupant profiles and a corresponding set of driving control parameters; and
causing the vehicle to be autonomously navigated along a driving route according to the comfort profile, based on one or more driving control parameter values included in the corresponding set of driving control parameters.

16. The non-transitory, computer-readable medium of claim 15, wherein:
at least one occupant profile included in the set of occupant profiles included in the particular comfort profiles specifies one or more aspects of a particular occupant located in a vehicle which is navigated according to the comfort profile in which the set of occupant profiles is included; and
the program of instructions, when executed by the at least one computer system, cause the at least one computer system to determine a correlation between the set of detected occupant profiles and the set of occupant profiles included in the particular comfort profile based on a determined correlation between aspects specified by the set of detected occupant profiles and aspects specified by the set of occupant profiles included in the particular comfort profile.

17. The non-transitory, computer-readable medium of claim 16, wherein the one or more characteristics specified by the at least one occupant profile comprises at least one of:
a specification of an occupant type of the particular occupant;
a specification of a position within the vehicle occupied by the particular occupant; and
a specification of an occupant identity of the particular occupant.

18. The non-transitory, computer-readable medium of claim 15, wherein:
the set of driving control parameters included in the selected comfort profile specify a set of target parameter values via which the vehicle is navigated.

19. The non-transitory, computer-readable medium of claim 18, wherein the parameter values via which the vehicle is navigated comprise at least one of:
an acceleration rate value which specifies a target rate at which the set of control element signals can cause the set of control elements included in the vehicle to accelerate the vehicle;
a turning rate value which specifies a target rate at which the set of control element signals can cause the set of control elements included in the vehicle to turn the vehicle;
a lane change rate value which specifies a target rate at which the set of control element signals can cause the set of control elements included in the vehicle to cause the vehicle to change between separate roadway lanes; and
a suspension stiffness value which specifies a target stiffness of the suspension at which the set of control element signals can cause the set of control elements included in the vehicle to adjust the suspension stiffness.

20. The non-transitory, computer-readable medium of claim 18, wherein:
at least one of the target parameter values is adjustable on a corresponding scale between a relative minimum value and a relative maximum value; and
the program of instructions, when executed by the at least one computer system, cause the at least one computer system to:
monitor a stress level of one or more of the detected occupants, based on processing sensor data generated by one or more sensor devices installed in the vehicle; and
adjust a value of at least one of the target parameter values along the corresponding scale based on monitoring the stress level of the one or more of the detected occupants.
